(19) United States
(12) Patent Application Publication
(10) Pub. No.: US 2007/0183135 A1
(43) Pub. Date: Aug. 9, 2007

(54) BACKLIGHT MODULE WITH THREADS FOR SUPPORTING A FILM

(76) Inventors: Wei-Hsiung Huang, Hsinchu City (TW); Jen-Hsiang Lin, Hsinchu County (TW); Kai-Yu Sun, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/426,947

(22) Filed: Jun. 28, 2006

(30) Foreign Application Priority Data
Feb. 6, 2006 (TW) 095103905

(51) Int. Cl. G09F 13/04

(52) U.S. Cl. 362/97

(57) ABSTRACT

Disclosed is a backlight module including at least a light source, at least a film, a frame, at least a back bezel, and at least a thread. The frame is used for loading the light source and has a base portion and a side wall portion. The thread is used for supporting the film, such that there is a space between the film and the base portion of the frame for containing the light source. Also, the two ends of the thread are connected to the side wall portion of the frame.

### BACKGROUND OF THE INVENTION

1. Field of the Invention

The present invention relates to a backlight module, and more particularly, to a direct type backlight film supporting structure applied to a liquid crystal display (LCD).

2. Description of the Prior Art

Please refer to FIG. 1. FIG. 1 illustrates a direct type backlight structure of a prior art LCD. The backlight module 100 includes a back bezel 110, a film 120, a light source 130, a supporting structure 140, and frame 150. The weight of the film 120 is proportional to the size. The size of the film 120 increases as the size of the LCD panel increases. Therefore, the supporting structure 140 is used for supporting the film 120 to prevent the film 120 from being deformed due to the increased weight. The most common supporting method is establishing the supporting structure 140 in the center part of the film 120. Additionally, the prior art supporting structure 140 is always a point supporting structure, as shown in FIG. 1. Practically, screwing or engaging is usually applied on such structures. Screwing usually consumes time and material; however, engaging may cause the supporting structure 140 to separate or break. Also, there is usually a reflector located between an inner side of the frame 110 and the light source 130. There is usually a hole at the location where the reflector and the supporting structure 140 meets. As a result, the complexity for pasting the reflector increases and making the reflector have a rough surface, thus a dark band occurs while the LCD panel displays images. Additionally, noise may occur when the supporting structure 140 and the film 120 contact each other. Damage may result to the film 120 at the location where the supporting structure 140 and the film 120 contacts.

### SUMMARY OF THE INVENTION

One objective of the present invention is providing a backlight module for resolving above-mentioned problems.

According the embodiment of the present invention, a backlight module is disclosed. The backlight module includes at least a light source, at least a film, a frame, a back bezel and at least a thread. The back bezel has a base portion and a side wall portion. The thread has two ends connected to the side wall portion for supporting the film.

According the embodiment of the present invention, a method for supporting a film of a backlight module is disclosed. The backlight module comprises at least a light source, at least a back bezel having a base portion and a side wall portion, and a back bezel for loading the light source. The method comprises: providing at least a thread, and connecting two ends of the thread to the side wall portion of the back bezel to support the film, such that there is a space between the film and the base portion of the back bezel for containing the light source.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a prior art direct type backlight module of a liquid crystal display.

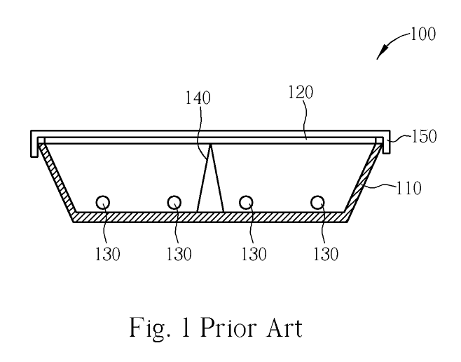

FIG. 2 is a schematic diagram illustrating a backlight module according to a first embodiment of the present invention.

FIG. 3 is a schematic diagram illustrating a backlight module according to a second embodiment of the present invention.

FIG. 4 is a schematic diagram illustrating a backlight module according to a third embodiment of the present invention.

FIG. 5 is a schematic diagram illustrating a backlight module according to a forth embodiment of the present invention.

FIG. 6 is a schematic diagram illustrating a backlight module according to a fifth embodiment of the present invention.

### DETAILED DESCRIPTION

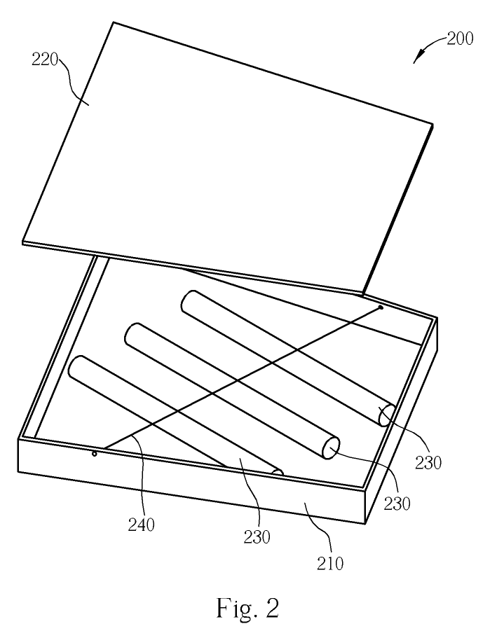

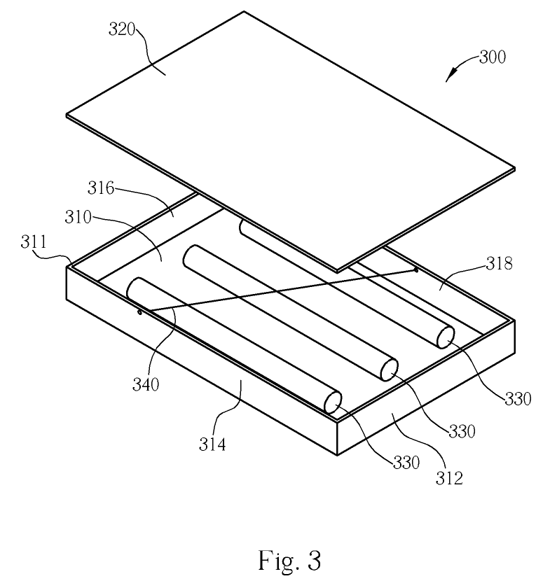

Please refer to FIG. 2. FIG. 2 is a schematic diagram illustrating a backlight module according to a first embodiment of the present invention. The backlight module 200 includes a frame 210, a film 220, a light source 230, and a thread 240. The functions of the frame 210, the film 220, and the light source 230 are the same as the respective counterparts found in a prior art direct type backlight module, thus further description is omitted for the sake of brevity. The frame 210 includes a base portion and a side wall portion defining a space in the center region wherein the space can contain the light source 230, regardless of the shape of the frame 210. The two ends of the thread 240 are connected to the side wall portion of the frame 210 to support the film 220 on the light source 230, thus there is space between the film 220 and the base portion of the frame 210 to contain the light source 230. Please note that the present invention does not require any limitation regarding the material of the thread 240, for example, either transparent or opaque material can be utilized for the thread 240 according to the present invention. Conventional LCD have a rectangular shape, therefore, the connection of a thread 340 and a back bezel 310 is explained utilizing a rectangular backlight module 300 shown in FIG. 3.

Please refer to FIG. 3. FIG. 3 is a schematic diagram illustrating a backlight module according to a second embodiment of the present invention. The backlight module 300 includes a back bezel 310, a frame 311, a film 320, a light source 330, and a thread 340. The functions of the back bezel 310, the film 320, and the light source 330 are the same as those of the corresponding counterparts in a prior art direct type backlight module, thus further description is omitted for the sake of brevity. Similarly, the thread 340 is used for supporting the film 320 to prevent the force of gravity from causing the film 320 to make contact with the light source 330 thereby resulting in the film 320 to become deformed. There is space between the film 320 supported by the thread 340 and the base portion of the back bezel 310 to contain the light source 330. As shown in FIG. 3, the backlight module 300 is a rectangular backlight module, and the frame 311 includes four side walls, where side walls 312 and 316 are parallel to each other and side walls 314 and 318 are parallel to each other. The two ends of the thread 340 are connected to the side walls 314 and 318 parallel to each other, respectively. Also, each light source 330 is a bar tube, and a long axis of the bar tube is parallel to the side walls 314 and 318. Similarly, these alternative designs fall in the scope of the present invention regardless of the orientation of the thread 340 in FIG. 3. Specifically, the thread 340 may or may not be parallel to the sides 312, 316. Additionally, the two ends of the thread 340 can be connected to the side walls 312 and 316 parallel to each other.

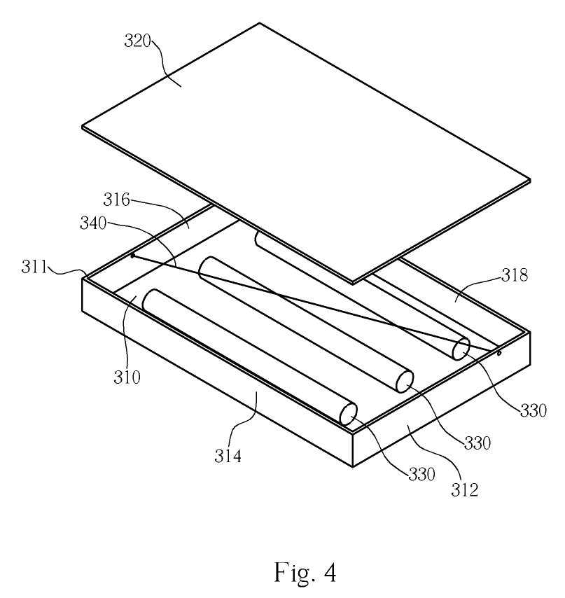

Please refer to FIG. 4. FIG. 4 is schematic diagram illustrating a backlight module according to a third embodiment of the present invention. According to FIG. 4, the side walls 314, 318 are parallel to the bar tube, and the two ends of the thread 340 are connected to the side walls 312 and 316 parallel to each other. Similarly, regardless of the thread 340 being parallel to the sides 312, 316 or not, these alternative designs fall in the scope of the present invention.

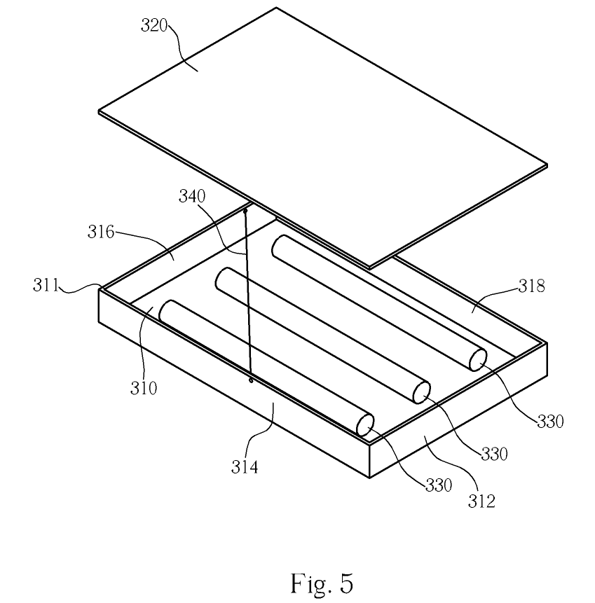

Please refer to FIG. 5. FIG. 5 is schematic diagram illustrating a backlight module according to a forth embodiment of the present invention. According to the present embodiment, the thread 340 is connected to two adjacent side walls. As shown in FIG. 5, the two ends of the thread 340 can be connected to the side walls 314 and 316, and such connection structure of the thread 340 can also support the film 320. The concept of the embodiment is connecting the two ends of the thread 340 to the two adjacent side walls of the frame 311, and all alternative designs of the embodiment obeying the concept fall in the scope of the present invention. For example, the two ends of the thread 340 can be connected to the side walls 312 and 314, the side walls 316 and 318, or the side walls 318 and 312, respectively. It should be noted that the two ends of the thread 340 can be connected to the two apexes of a diagonal line of the rectangular frame 311.

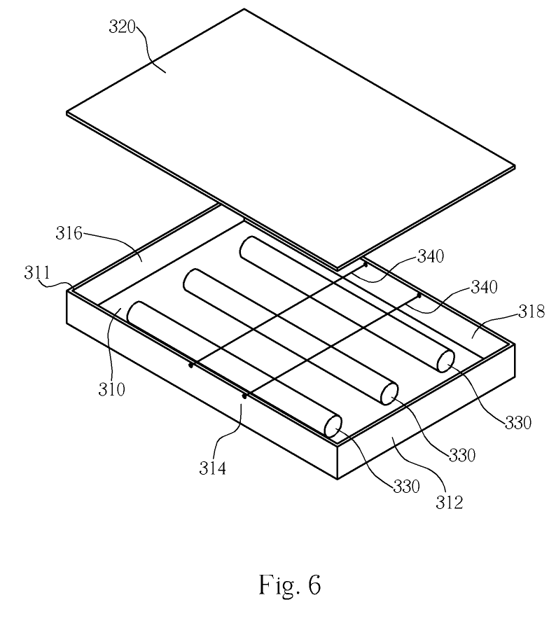

Please refer to FIG. 6. FIG. 6 is schematic diagram illustrating a backlight module according to a fifth embodiment of the present invention. The number of the threads 340 implemented for supporting the film 320 can be more than one, and this embodiment takes two threads 340, for example, to explain the structure of a plurality of threads 340. As shown in FIG. 6, the two threads 340 are parallel to each other, and the two ends of each of the threads 340 are connected to the side walls 314 and 318 parallel to each other, respectively. It should be noted that no matter the threads 340 are parallel to the side walls 312, 316 or not, these alternative designs fall in the scope of the present invention. Also, the two ends of each of the threads 340 can be connected to the side walls 312 and 316 parallel to each other, respectively, and no matter the threads 340 are parallel to the sides 314, 318 or not, these alternative designs all fall in the scope of the present invention. Additionally, the threads 340 can be connected to the two adjacent side walls such as side walls 312 and 314, side walls 314 and 316, side walls 316 and 318, or side walls 318 and 312, respectively.

As described above, it can save time and material for setting up the point supporting structure by utilizing at least a thread to replace prior art screwing or engaging. Also, as mentioned above, the prior art point supporting structure may causes the parts to separate or break and also increase the complexity for adhering reflection slices, such that the reflector may have a rough surface, and a dark band may occur while the LCD panel is displaying. However, these problems are solved using at least a thread. Compared to the prior point supporting structure, using at least a thread can offer uniform supporting force, instead supporting force focusing on a point, upon the film to better support the film. In addition, neither the point damage to the film nor the unwanted noise is introduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A backlight module, comprising:
a back bezel having a base portion and a side wall portion;
at least one light source disposed in the back bezel;
at least one film; and
at least one thread having two ends connected to the side wall portion for supporting the film.

2. The backlight module of claim 1, wherein the side wall portion forms a rectangle, and includes a first side wall and a third side wall parallel to each other, and a second side wall and a forth side wall parallel to each other, and wherein the two ends of the thread are connected to the second and the forth side walls, respectively.

3. The backlight module of claim 2, wherein the thread is parallel to the first and the third side walls.

4. The backlight module of claim 1, wherein the side wall portion forms a rectangle, and includes a first side wall and a third side wall parallel to each other, and a second side wall and a forth side wall parallel to each other, and wherein the two ends of the thread are connected to the first and the third side walls, respectively.

5. The backlight module of claim 4, wherein the thread is parallel to the second and the forth side walls.

6. The backlight module of claim 1, wherein the side wall portion forms a rectangle, and the two ends of the thread are connected to two adjacent side walls.

7. The backlight module of claim 1, wherein the side wall portion forms a rectangle, and the two ends of the thread are connected to apexes of a diagonal line of the rectangular.

8. The backlight module of claim 1, wherein the backlight module comprises a plurality of threads, and the threads are parallel to each other.

9. A method for supporting a film of a backlight module, the backlight module comprising at least a light source, at least a film and a back bezel utilized for loading the light source, the back bezel including a base portion and a side wall portion, the method comprising:
providing at least a thread, and connecting two ends of the thread to the side wall portion of the back bezel to support the film, thereby allowing a space between the film and the base portion of the back bezel to contain the light source.

10. The method of claim 9, wherein the side wall portion forms a rectangular, and includes a first side wall and a third side wall parallel to each other, and a second side wall and a forth side wall parallel to each other; and the two ends of the thread are connected to the second and the forth side walls, respectively, while connecting the thread.

11. The method of claim 10, wherein the thread is parallel to the first and the third side walls.

12. The method of claim 9, wherein the side wall portion forms a rectangle, and includes a first side wall and a third side wall parallel to each other, and a second side wall and a forth side wall parallel to each other; the two ends of the thread are connected to the first and the third side walls, respectively, while connecting the thread.

13. The method of claim 12, wherein the thread is parallel to the second and the forth side walls.

14. The method of claim 9, wherein the side wall portion forms a rectangle, and the two ends of the thread are connected to two adjacent side walls while connecting the thread.

15. The method of claim 9, wherein the side wall portion forms a rectangle, and the two ends of the thread are connected to apexes of a diagonal line of the rectangular while connecting the thread.

16. The method of claim 9, further comprising utilizing a plurality of threads to support the film, wherein the threads are parallel to each other.
